(19) United States
(12) Patent Application Publication
(10) Pub. No.: US 2025/0222895 A1
(43) Pub. Date: Jul. 10, 2025

(54) BELT RETRACTOR HAVING A DEVICE FOR SENSING THE EXTENSION LENGTH OF THE BELT STRAP

(71) Applicant: AUTOLIV DEVELOPMENT AB, Vargarda (SE)

(72) Inventors: Fredrik FYHR, Vargarda (SE); Linus LARSSON, Alingsas (SE); Elias MATHIASSON, Alingsas (SE)

(21) Appl. No.: 18/853,954

(22) PCT Filed: Apr. 4, 2023
(86) PCT No.: PCT/EP2023/058764

§ 371 Date: Oct. 3, 2024

(30) Foreign Application Priority Data
Apr. 7, 2022 (DE) 10 2022 108 446.9

(51) Int. Cl. B60R 22/34; B60R 22/02

(52) U.S. Cl. CPC B60R 22/34; B60R 22/02; B60R 2022/029

(57) ABSTRACT

A belt retractor having a device for sensing the extension length of a safety belt, wherein:
the belt retractor has a frame which can be fastened fixedly to the vehicle and a belt shaft mounted rotatably in the frame, on which belt shaft the safety belt can be wound, and the device for sensing the extension length has a first rotary encoder and a first rotational angle sensor, and,
a reduction gear unit is provided which reduces the rotation of the belt shaft to a rotation of the first rotary encoder with a lower speed, and
a second rotary encoder and a second rotational angle sensor are provided, and
the second rotary encoder is driven by the belt shaft at a speed greater than the speed of the first rotary encoder.

The present invention relates to a belt retractor having a device for sensing the extension length of the belt strap having the features of the preamble of claim 1.

Belt retractors are used, for example, in the safety belt systems of motor vehicles, which restrain the occupant in the event of an accident and prevent the occupant from hitting hard surfaces, such as the windshield, and thereby sustaining serious injuries. Furthermore, in modern motor vehicles, such belt retractors are equipped with irreversible or reversible belt tensioners, which pull out any slack in the seat belt system in the event of an accident or in a pre-accident phase, thereby further improving the coupling of the occupant to the motor vehicle. In particular, in the case of reversible belt tensioners, which, for example, have an electric motor that drives the belt shaft in the winding direction, the belt force generated can be controlled so that a different belt force can be generated depending on the type of occupant, the seating position or the extension length of the belt strap. The extension length of the belt strap is of particular importance here, since the determined extension length of the belt strap can also be used to detect certain states of the seat belt system, such as “the occupant has just fastened the belt” or “the occupant has just unfastened the belt.” In the cases mentioned, it may be useful to increase the belt force briefly in order to roll the belt into a parking position or to remove any slack created when buckling up. Furthermore, belt retractors are known which have a pyrotechnic pre-tensioning device which is only intended to be triggered in the event of an accident if the belt is fastened. In this case too, it is important to determine the seat belt status.

Another problem with belt retractors is that they can become unintentionally blocked if the belt is retracted quickly. To overcome this problem, various systems are known which switch off the sensor system depending on whether the extension length of the belt strap falls below a predetermined value when the belt is fed in. Even with belt retractors with an ELR/ALR function, switching from ELR to ALR operation occurs depending on whether a predetermined extension length of the belt strap is exceeded. Furthermore, modern belt retractors with two or more force limitation levels are known, where the force limitation level can be switched depending on the extended extension length of the belt strap.

It can therefore be useful for various reasons to sense the extension length of the belt strap, whereby the accuracy of the sensing is of particular importance, since the belt retractor is a safety-relevant component and incorrect control can lead to considerable damage.

From DE 41 32 876 C2, for example, a belt retractor is known which has a mechanical device which senses a predetermined extension length of the belt strap and switches the belt retractor from an ELR operation to an ALR operation when the extension length of the belt strap is exceeded. The device comprises a mechanical counting gear which mechanically switches the belt retractor via a rocker switch when the specified switching point is exceeded. Since this solution is a mechanical device with various interlocking parts, an improvement in the accuracy of the sensing can only be achieved with a complex and very high level of manufacturing precision. Furthermore, with this solution, a switching cam must be provided for each extension length of the belt strap to be sensed, so that not an unlimited number of extension length of the belt straps can be sensed, and each extension length of the belt strap to be sensed represents a design effort.

From publication DE 10 2018 113 582 A1, a safety belt system with a belt retractor is known in which a belt spool angle sensor is provided on the belt retractor, which comprises a rotary encoder, a rotational angle sensor and a multi-stage reduction gear. Due to the reduction gear, the rotary motion of the belt shaft is reduced to a lower speed of the rotary encoder, which in turn enables the absolute extension length of the seat belt to be sensed.

Against this background, the object of the invention is to provide a belt retractor with a device for sensing the extension length of the belt strap, which enables sensing of the extension length of the belt strap with an improved resolution.

In order to achieve the object, a seatbelt retractor having the features of claim 1 is proposed. Further preferred developments of the invention can be taken from the dependent claims, the figures and the associated description.

According to the basic idea of the invention, it is proposed that a second rotary encoder and a second rotational angle sensor are provided, and the second rotary encoder is driven by the belt shaft to a speed that is greater in relation to the speed of the first rotary encoder. The proposed additional second rotary encoder and rotational angle sensor and their higher speed provide a second additional signal which enables a higher resolution of the rotary motion of the belt shaft. The signals from the two rotational angle sensors can be combined with each other, i.e., the extension length is determined based on the signal from the first rotational angle sensor, while the signal from the second rotational angle sensor allows a conclusion to be drawn about the rotational angle position of the belt shaft due to the higher speed of the second rotary encoder. The higher the speed of the second rotary encoder, the higher the resolution of the rotational angle position of the belt shaft.

It is further proposed that the second rotary encoder is arranged on a gear of the reduction gear. The reduction gear is designed to reduce the rotary motion of the belt shaft for the first rotational angle sensor. To realize a cost-effective compact design, this reduction gear, which was already provided anyway, is now also used for arranging the second rotary encoder. The different speed of the second rotary encoder can be implemented very easily by arranging the second rotary encoder on a gear of the reduction gear, which is arranged between the first rotary encoder and the belt shaft and rotates at a higher speed than the first rotary encoder.

A particularly large and easy-to-implement speed difference between the second rotary encoder and the first rotary encoder can be achieved by the gear of the reduction gear on which the second rotary encoder is arranged being a drive gear of the reduction gear that is connected in a rotationally fixed manner to the belt shaft. The second rotary encoder therefore rotates at an identical speed to the belt shaft, so that the signal from the second rotary encoder correlates directly with the rotary motion of the belt shaft and reproduces it 1:1.

It is further proposed that the reduction gear has a rotatably mounted output gear that is fixedly arranged on the belt retractor and that the first rotary encoder is arranged on the output gear. Due to the proposed further development, the first rotary angle encoder does not perform any further movement apart from its rotation about its axis of rotation, and the rotational angle sensor can be arranged in a fixed position relative to the first rotary encoder. This allows a simplified, compact design to be realized while at the same time accurately sensing the rotary motion of the first rotary encoder.

It is further proposed that an intermediate gear arranged between the drive gear and the output gear is provided, and the intermediate gear is formed by a two-stage gear with two toothings having different diameters and a different number of teeth which intermediate gear, with the toothing having the larger number of teeth, meshes with the toothing of the drive gear, and, with the toothing having the smaller number of teeth, meshes with the toothing of the output gear. The intermediate gear thus forms a two-stage reduction of the rotary motion of the drive gear to the output gear in a very compact design.

It is further proposed that the belt retractor has a first housing cap held on the frame, and the reduction gear has at least one gear rotatably mounted on a bearing journal of the housing cap. This can be the drive gear, the output gear or even a third intermediate gear, depending on how many gears the reduction gear has and how it is constructed. By mounting the gear on the housing cap fixed to the frame, the gear is rotatably mounted and at the same time fixed to the frame in a fixed spatial relationship to the belt shaft and the parts interacting with it, such as its extension for driving the drive wheel.

It is further proposed that a second housing cap is provided which covers the reduction gear towards the outside and to which the first and/or the second rotational angle sensor are fastened. The second housing cap covers the reduction gear towards the outside and thus protects the reduction gear from external influences. At the same time, by fastening the first and/or second rotational angle sensor, it also serves to fix the rotational angle sensors relative to the reduction gear and the rotary encoders held thereon.

It is further proposed that the second housing cap has at least one opening which exposes the first rotary encoder and/or the second rotary encoder and is covered by the first and/or the second rotational angle sensor. The opening exposes the respective rotary encoder so that it is freely accessible from the outside. The opening is then covered again by the respective rotational angle sensor so that there is no wall between the rotary encoder and the rotational angle sensor that would impair the signal, and the rotary encoder and the rotational angle sensor interact directly in terms of signaling.

It is further proposed that the opening is designed as a slotted hole. The slotted hole opening is advantageous because it can compensate for manufacturing inaccuracies.

The second housing cap may preferably be attached to the first housing cap or to a part firmly connected thereto. Thus, the fastening chain of the first and second housing caps can be used to achieve a fixed spatial association of the rotational angle sensors to the rotary encoders so that, after assembly, the rotational angle sensors are aligned with the rotary encoders held on the first housing cap solely by their fastening to the second housing cap, without them having to be additionally adjusted or aligned.

It is further proposed that the reduction gear reduces the rotary motion of the belt shaft to the extent that the first rotary encoder rotates by less than one revolution about its axis of rotation from the rotational angle position of the belt shaft when the safety belt is completely wound up to the rotational angle position of the belt shaft when the safety belt is fully extended. The proposed solution allows the extension length of the seat belt to be clearly sensed, since each rotational angle position of the rotary encoder can be associated with exactly one extension length of the seat belt.

For this purpose, the reduction gear may preferably have a reduction ratio of at least 1:5. The belt shaft therefore makes at least five revolutions while the rotary encoder makes one revolution. The five revolutions correspond to an extension length of the seat belt of at least 750 mm, which corresponds to the minimum extension length of the seat belt that the occupant pulls out on average during the buckling-up process.

The invention is explained below on the basis of preferred embodiments, with reference to the accompanying figures. In the figures:

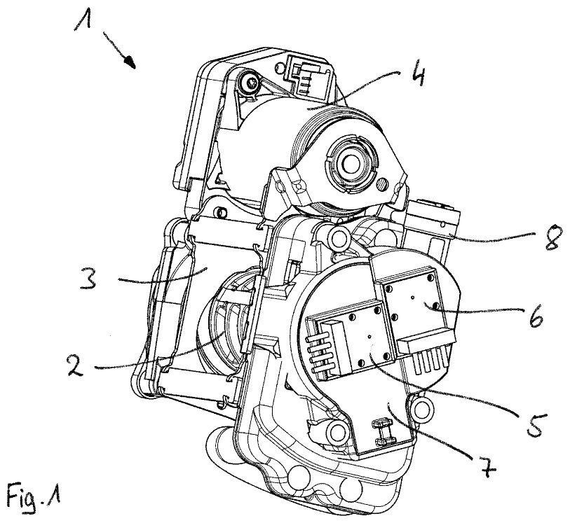

FIG. 1 shows a seat belt retractor according to the invention according to first second exemplary embodiment in an oblique view; and

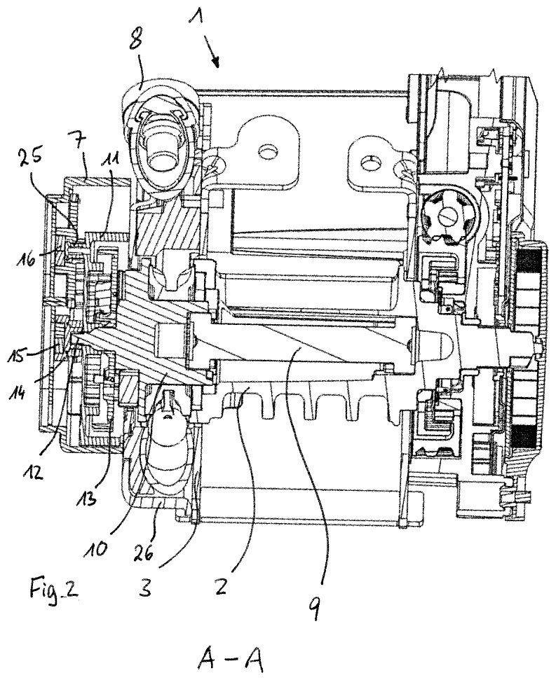

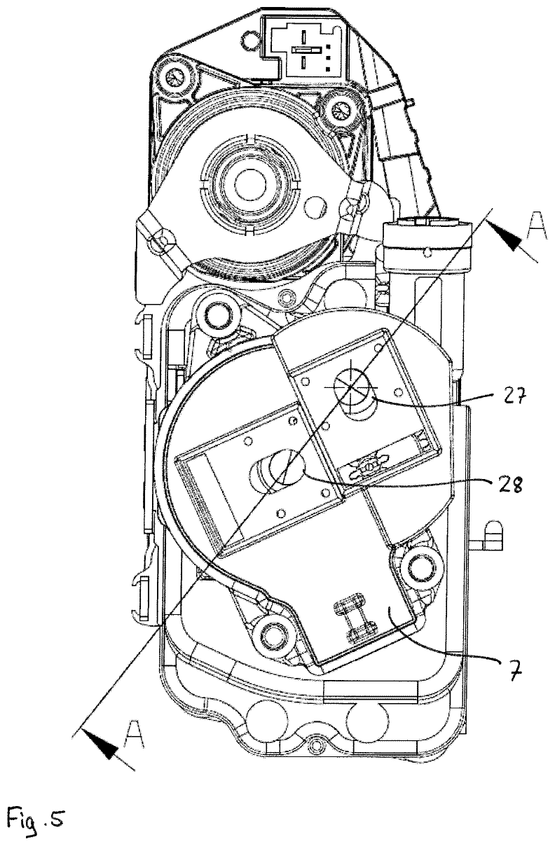

FIG. 2 shows a sectional view the belt retractor of FIG. 5 in section direction A-A; and

FIG. 3 shows the first housing cap with the reduction gear of the belt retractor of FIG. 1 in front view;

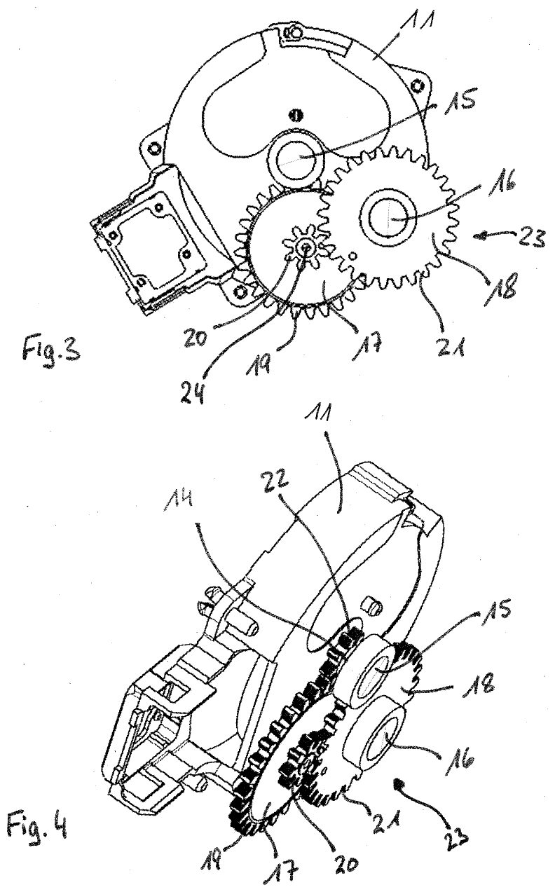

FIG. 4 shows the first housing cap with the reduction gear of the belt retractor of FIG. 1 in an oblique view; and

FIG. 5 shows the belt retractor of FIG. 1 without rotational angle sensors;

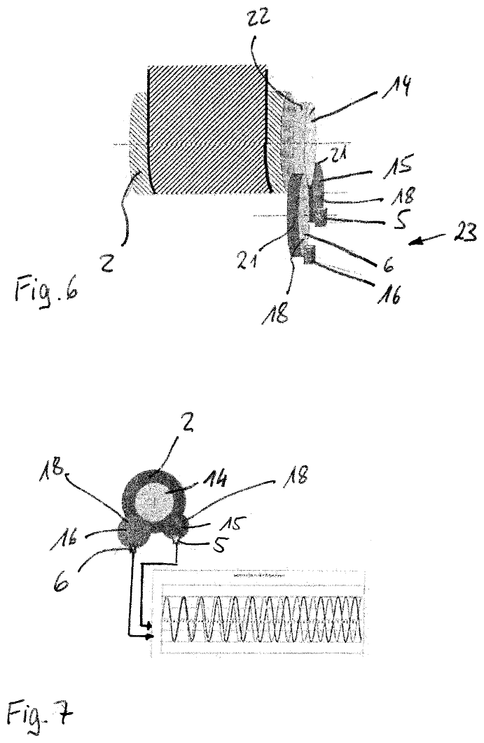

FIG. 6 shows a belt retractor according to the invention according to a second embodiment; and

FIG. 7 shows the signal image of the belt retractor of FIG. 6.

FIG. 1 reveals a belt retractor 1 according to the invention with a frame 3 which can be fixedly fastened to the vehicle and a belt shaft 2 rotatably mounted therein. A safety belt (not shown) can be wound onto the belt shaft 2, as has long been known in the art. Furthermore, a reversible belt tensioner 4 and an irreversible pyrotechnic belt tensioner 8 are provided on the belt retractor 1.

Furthermore, the belt retractor 1 is covered toward the outside on one side by a second housing cap 7, on which, as will be explained in more detail below, a first rotational angle sensor 6 and a second rotational angle sensor 5 are held, both of which are designed as Hall sensors.

In FIG. 2, the same belt retractor 1 as shown in FIG. 5 can be seen in an enlarged sectional view along the section direction A-A. The irreversible belt tensioner 8 has a drive wheel 10 which is connected in a rotationally fixed manner to one end of a torsion bar 9, which in turn is connected in a rotationally fixed manner to the belt shaft 2 at its other end. The drive wheel 10, the torsion bar 9 and the belt shaft 2 form a rotationally fixed connection, i.e., a unit, until the torsion bar 9 is activated. Furthermore, a blocking pawl and a control disk 13 are mounted on the drive wheel 10, which together form the blocking device of the belt retractor 1. The drive wheel 10 of the irreversible belt tensioner 8 together with the drive unit is covered toward the outside by a tensioner housing 26, which is fastened to the frame 3 of the belt retractor 1. The control disk 13, which is rotatably mounted on the drive wheel 10, is covered toward the outside by a first housing cap 11, which in turn is attached to the tensioner housing 26 of the irreversible belt tensioner 8 and is thus fixed to the frame.

An axial extension 12 is provided on the drive wheel 10, which, due to the rotationally fixed connection with the belt shaft 2 described above, can also be regarded as a rotationally fixed extension 12 of the belt shaft 2. The extension 12 is arranged coaxially to the axis of rotation of the belt shaft 2 and passes through a central opening in the first housing cap 11.

A drive gear 14 of a reduction gear 23, which can be seen enlarged in FIGS. 3 and 4, is held in a rotationally fixed manner on the end of the extension 12 which passes through the first housing cap 11. The reduction gear 23 comprises, in addition to the drive gear 14, an intermediate gear 17 and an output gear 18. The intermediate gear 17 and the output gear 18 are each rotatably mounted on bearing journals 24 and 25 of the first housing cap 11 and are fixed in place (see FIGS. 2 and 3).

The drive gear 14 has a toothing 22, while the intermediate gear 17 has two toothings 19 and 20 and the output gear 18 in turn has a toothing 21. The intermediate gear 17 thus has a two-stage toothing with a toothing 19 on a larger outer diameter with 28 teeth and a toothing 20 on a smaller diameter with 8 teeth. The toothing 22 of the drive gear 14 has 8 teeth and the toothing 21 of the output gear 18 has 28 teeth. The toothing 22 of the drive gear 14 has an identical number of teeth and an identical diameter as the toothing 20 of the intermediate gear 17 with the smaller number of teeth. The toothing 21 of the output gear 18 has an identical number of teeth and an identical diameter as the toothing 19 of the intermediate gear 17 with the larger number of teeth.

The drive gear 14 meshes with its toothing 22 in the toothing 19 of the intermediate gear 17 with the larger number of teeth, while the output gear 18 meshes with its toothing 21 in the toothing 20 of the intermediate gear 17 with the smaller number of teeth. This results in a two-fold reduction of the rotary motion of the belt shaft 2, initially in a first stage into a lower speed of the intermediate gear 17 in the ratio of 8/28 and further in a second stage into a further reduced speed of the output gear 18, again in the ratio of 8/28. This results in a total reduction of the rotary motion of the belt shaft 2 to the output gear 18 in a ratio of 1/12.25. In other words, it follows that the output gear 18 has completed one revolution when the belt shaft has completed 12.25 revolutions.

A first rotary encoder 16 in the form of a two-pole magnet is provided on the output gear 18, which first rotary encoder, due to its fixed arrangement on the output gear 18, executes an identical rotary motion during the rotary motion of the output gear 18, i.e., also executes one revolution during the 12.25 revolutions of the belt shaft 2. Furthermore, a second rotary encoder 15 in the form of a two-pole magnet is also held in a rotationally fixed manner on the drive gear 14, which second rotary encoder, due to the rotationally fixed connection, executes a rotary motion identical to the rotary motion of the drive gear 14, which corresponds to the rotary motion of the belt shaft 2 due to the rotationally fixed connection of the drive gear 14 to the belt shaft 2 described above. The first rotary encoder 16 and the second rotary encoder 15 are preferably identical. Furthermore, the toothings 22 and 20 with the smaller number of teeth and the toothings 19 and 21 with the larger number of teeth are also identical. The first rotary encoder 16 is connected in a rotationally fixed manner to the output gear 18 and, for this purpose, is rotationally fixed in a shape-corresponding recess. For this purpose, the first rotary encoder 16 can be glued into the recess, positively connected, pressed in or also fixed in a rotationally fixed manner by an injection molding process of the output gear 18. In the same way, the second rotary encoder 15 may also be fixed in a recess of the drive gear 14.

Furthermore, a second housing cap 7 is fixed to the frame on the tensioner housing 26 and supports the first rotational angle sensor 6 and the second rotational angle sensor 5. The first rotational angle sensor 6 is positioned on the second housing cap 7 by means of a bracket in such a way that its sensor surface is opposite the first rotary encoder 16 so that the rotary motion of the first rotary encoder 16 leads to a signal in the first rotational angle sensor 6. The second rotational angle sensor 5 is also positioned by means of a bracket in such a way that its sensor surface is opposite the second rotary encoder 15 so that the rotary motion of the second rotary encoder 15 leads to a signal in the second rotational angle sensor 5. To attach the rotational angle sensors 5 and 6, two receptacles are provided on the second housing cap 7, in which the rotational angle sensors 5 and 6 are attached with their brackets.

Since the second rotary encoder 15 is arranged on the drive gear 14 arranged coaxially to the axis of rotation of the belt shaft 2, the second rotational angle sensor 5 is also arranged centered, i.e., in the center, on the second housing cap 7 in an overlap of the axis of rotation of the belt shaft 2. The tensioner housing 26 is firmly held on the frame 3 of the belt retractor 1 and forms the fastening surface for the first housing cap 11. The tensioner housing 26 simultaneously forms the fastening surface for the second housing cap 7. This means that the first housing cap 11 and the second housing cap 7 are both firmly attached to the frame. Furthermore, the two housing caps 11 and 7 are both attached to the same part, namely the tensioner housing 26, so that they are fixed in a fixed spatial relationship to one another, with the tensioner housing 26 forming the common base. Since the output gear 18 with the first rotary encoder 16 arranged thereon is held on the bearing journal 25 of the first housing cap 11 and the first rotational angle sensor 6 is held on the second housing cap 7, the first rotational angle sensor 6 is in a fixed spatial assignment to the first rotary encoder 16 solely by the fastening of the second housing cap 7. Furthermore, the belt shaft 2 is mounted in the frame 3, to which the second housing cap 7 is also indirectly attached via the tensioner housing 26. Thus, the belt shaft 2 with the drive wheel 10 and the extension 12 including the drive gear 14 arranged thereon and the second rotational angle sensor 15 is in a fixed spatial relationship to the second housing cap 7 and the second rotational angle sensor 5 held thereon.

Due to the different association of the two rotary encoders 15 and 16 in the reduction gear 23, they perform different rotary motions. The first rotary encoder 16 carries out the reduced rotary motion described above with a maximum of one revolution starting from the fully wound up seat belt until the seat belt is completely unwound. The first rotational angle sensor 6 thus generates a signal that directly correlates to the extension length of the seat belt. The second rotary encoder 15 is held on the drive gear 14 and thus rotates with a non-reduced rotary motion identical to that of the belt shaft 2. The second angle sensor 15 thus rotates significantly faster and at a higher speed than the first angle sensor 16 so that the second rotational angle sensor 5 delivers a second signal with a higher resolution of the rotary motion of the belt shaft 2, which in combination with the signal of the first rotational angle sensor 6 not only enables a sensing of the extension length but also a more precise sensing of the angle of rotation of the belt shaft 2. In the present case, the second rotary encoder 15 even rotates at an identical speed as the belt shaft 2 so that the signal of the second rotational angle sensor 5 even directly maps the rotary motion of the belt shaft 2 1:1.

In FIG. 5, the belt retractor 1 according to the invention can be seen as shown in FIG. 1 without the rotational angle sensors 5 and 6. In the second housing cap 7, two slotted hole openings 27 and 28 are provided, which are positioned so that they are arranged in the receptacles for the bracket of the rotational angle sensors 5 and 6, and the rotary encoder 15 and 16 arranged underneath are exposed. Furthermore, the slotted hole openings 27 and 28 in the receptacles of the second housing cap 7 are aligned with their longitudinal axes in the direction of the insertion direction of the rotational angle sensors 5 and 6, so that manufacturing inaccuracies of the brackets of the rotational angle sensors 5 and 6, the receptacles in the second housing cap 7, the shape of the second housing cap 7 and the fastening of the second housing cap 7 do not result in the rotational angle sensors 5 and 6 and the rotary encoders 15 and 16 being separated from one another by the wall of the second housing cap 7.

FIG. 6 shows a belt retractor 1 according to the invention according to a second embodiment. The belt shaft 2 is here connected in a rotationally fixed manner to a drive gear 14, which meshes with its toothing 22 with the toothing 21 of two output gears 18. The output gears 18 have a different outer diameter with a different number of teeth in the toothing 21 so that they are driven by the drive gear 14 at different speeds. The output gears 18 simultaneously carry markings, magnets or the like and thus simultaneously act as rotary encoders 15 and 16. Opposite the rotary encoders 15 and 16, rotational angle sensors 5 and 6 are arranged, respectively, which generate the signals shown in FIG. 7 when the belt shaft 2 and the output gears 18 driven thereby rotate. The reduction gear 23 is realized here by the rotary connection of the drive gear 14 with the output gears 18, wherein the output gears 18 can also rotate at a higher speed than the drive gear 14 and the belt shaft 2.

The left output gear 18 in the illustration has a larger outer diameter with a larger number of teeth in the toothing 21 than the right output gear 18 in its toothing 21. Thus, the left output gear 18 is driven by the drive gear 14 to rotary motion at a lower speed than the right output gear 18. The left output gear 18 thus corresponds to the first rotary encoder 16 according to the invention and the right output gear 18 corresponds to the second rotary encoder 15 according to the invention, which is driven at the higher speed. The two rotational angle sensors 5 and 5 each generate a sinusoidal signal with a different frequency during the rotary motion of the belt shaft 2. Said different frequency results in a changing phase shift of the signals to each other, which enables a higher resolution in determining the rotational angle position of the belt shaft 2. The absolute extension length of the belt can be determined solely by evaluating one of the signals from the rotational angle sensors 5 or 6, taking into account the reduction ratio.

Basically, the transmission of the rotary motion in the reduction gear 23 and, in particular, from the drive gear 14 to the output gear(s) 18 with the toothings 21 and 22 is described. However, it is easily possible to transmit the rotary motion solely via a frictional connection or another type of power transmission, provided that the different rotational speeds of the drive gear 14 and the output gears 18 are realized during the rotary motion of the belt shaft 2.

1. A belt retractor with a device for sensing the extension length of a safety belt, wherein:
the belt retractor has a frame that can be fixed to the vehicle and a belt shaft that is rotatably mounted in the frame and on which the safety belt can be wound, and
the device for sensing the extension length comprises a first rotary encoder and a first rotational angle sensor, and
a reduction gear unit is provided which reduces the rotational movement of the belt shaft to a rotational movement of the first rotary encoder at a slower rotational speed,
wherein
a second rotary encoder and a second rotational angle sensor are provided, and
the second rotary encoder is driven by the belt shaft to a rotational speed that is greater than the rotational speed of the first rotary encoder.

2. The belt retractor according to claim 1, wherein
the second rotary encoder is arranged on a gear of the reduction gear unit.

3. The belt retractor according to claim 2, wherein
the gear is a drive gear of the reduction gear unit that is connected to rotate conjointly with the belt shaft.

4. The belt retractor according to claim 1, wherein
the reduction gear unit has a rotatably mounted output gear arranged in a fixed position on the belt retractor, and
the first rotary encoder is arranged on the output gear.

5. The belt retractor according to claim 2, wherein
an intermediate gear arranged between the drive gear and the output gear is provided, and
the intermediate gear is formed by a two-stage gear with two toothings having different diameters and a different number of teeth which, with the toothing having the larger number of teeth, meshes with the toothing of the drive gear, and, with the toothing having the smaller number of teeth, meshes with the toothing of the output gear.

6. The belt retractor according to claim 1, wherein
the belt retractor has a first housing cap held on the frame, and
the reduction gear unit has at least one gear rotatably mounted on a bearing journal of the first housing cap.

7. The belt retractor according to claim 1, wherein
a second housing cap is provided which covers the reduction gear unit to the outside and
to which the first and/or the second rotational angle sensor are fastened.

8. The belt retractor according to claim 7, wherein
the second housing cap has at least one opening which
exposes the first rotary encoder and/or the second rotary encoder and is covered by the first and/or the second rotational angle sensor.

9. The belt retractor according to claim 8, wherein
the opening is designed as a slotted hole opening.

10. The belt retractor according to claim 6, wherein
the second housing cap is attached to the first housing cap or to a part firmly connected thereto.

11. The belt retractor according to claim 1, wherein
the reduction gear unit reduces the rotational movement of the belt shaft to the extent that the first rotary encoder rotates by less than one revolution about its axis of rotation from the rotational angle position of the belt shaft when the safety belt is completely wound up to the rotational angle position of the belt shaft when the safety belt is fully extended.

12. The belt retractor according to claim 1, wherein
the reduction gear has a reduction ratio of at least 1:5.
